(19) United States
(12) Patent Application Publication
(10) Pub. No.: US 2007/0230918 A1
(43) Pub. Date: Oct. 4, 2007

(54) Video Quality Enhancement and/or Artifact Reduction Using Coding Information From a Compressed Bitstream

(76) Inventors: Sandeep Dalal, Cortlandt Manor, NY (US); Yibin Yang, Pine Brook, NJ (US); Lilla Boroczky, Mt. Kisco, NY (US); Cornelis Conradus Adrianus Maria Van Zon, Cold Spring, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/599,199

(22) PCT Filed: Mar. 29, 2005
(86) PCT No.: PCT/IB05/51029

§ 371 Date: Sep. 22, 2006

Related U.S. Application Data
(60) Provisional application No. 60/557,224, filed on Mar. 29, 2004.

(51) Int. Cl. H04N 7/01; H04N 7/12; H04N 7/26

(52) U.S. Cl. 386/109; 375/240.01; 386/131; 386/44

(57) ABSTRACT

A system and method of processing a digital video signal for display on a display device, includes decoding an encoded digital video signal to produce a decoded digital video signal having a video source format; extracting coding information from the encoded digital video signal; executing a video quality improvement algorithm on the decoded digital video signal having the video source format using the extracted coding information, to produce a processed decoded digital video signal having the video source format; and converting the processed decoded digital video signal from the video source format to a video display format suitable for display on the display device. The system and method enhance the quality and/or reduce video artifacts in a video signal after it is decoded and prior to display on a display device.

This application claims priority under 35 U.S.C. § 120 and 35 USC § 365(c) to International Patent Application serial number IB2003/0057 filed on Dec. 4, 2003 and entitled “A Unified Metric For Digital Video Processing (UMDVP),” to Boroczky, et al; to International Patent Application Number IB2003/0055 filed Nov. 28, 2003 and entitled “System and Method for Joint Video Enhancement and Artifact Reduction for Coded Digital Video”, to Boroczky, et al.; and to U.S. patent application Ser. No. 10/029,828. All of these applications are incorporated herein by reference in their entirety as if fully set forth herein.

This invention pertains to the digital video signal processing, and in particular, to a system and method of enhancing video quality and/or reducing coding artifacts in a decoded video signal by using coding data from the coded video signal.

Moving Picture Expert Group (MPEG) video compression, or coding, technology facilitates many current and emerging video products (e.g., DVD players, high definition television decoders, and video conferencing) by requiring less storage and less bandwidth. However, it is well known that such lossy compression technology (MPEG-1, MPEG-2, MPEG-4, H.26x, etc.) can cause the introduction of coding artifacts and decrease picture quality of the video signal.

Sometimes low bit rates are chosen to achieve bandwidth efficiency. The lower the bit rates, the more objectionable become the impairments introduced by the compression encoding and decoding processing. For example, for digital terrestrial television broadcasting of standard-definition video, a bit rate of around 6 Mbit/s is considered a good compromise between picture quality and transmission bandwidth efficiency (see P. N. Tudor, “MPEG-2 Video Compressions,” IEEE Electronics & Communication Engineering Journal, December 1995, pp. 257-264). However, broadcasters often broadcast digital video signals having bit rates far lower than 6 Mbit/s so that they can provide more programs per digital television channel. So artifacts are generated and picture quality is reduced.

Therefore, recently, as discussed in International Patent Application Number IB2003/0055 filed Nov. 28, 2003 and entitled “System and Method for Joint Video Enhancement and Artifact Reduction for Coded Digital Video,” video display devices have been provided with systems and methods for post-processing the decoded video signal for display to enhance the picture quality and/or reduce the video artifacts.

Meanwhile, digital video sources such as DVDs, video tapes, broadcast signals, etc. often provide coded digital video signals that are digitally compressed or coded in a different video format than the video format with which they will be displayed. For example, motion pictures/film sequences are typically encoded or compressed in the progressive scan format at a frame rate of 24 frames/second that has been used for decades. On the other hand, many video display devices such as television receivers display video signals using an interlaced video display format of 50 or 60 fields per second.

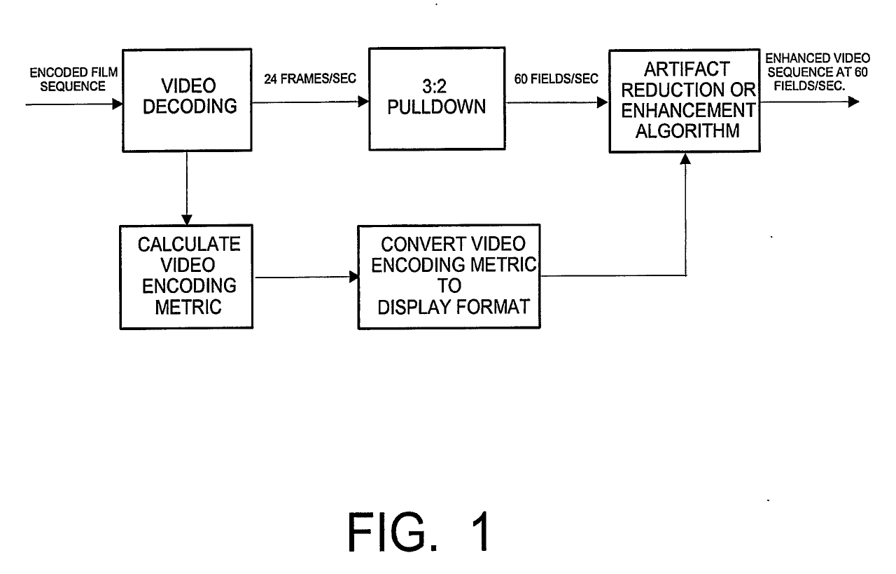

FIG. 1 shows an exemplary block diagram illustrating a system and method of video signal enhancement and/or artifact reduction using coding information from a coded digital video signal. The coded digital video signal may have been encoded using MPEG-1, MPEG-2, MPEG-4, H.26x, or any other desired video-encoding standard. For ease of explanation, hereafter it will be assumed that the encoded digital video signal has been encoded according to the MPEG-2 standard. Furthermore, in the example of FIG. 1, the encoded digital video signal represents a film sequence that has been encoded at a source frame rate of 24 frames/second.

In a block 110, a video decoder decodes the encoded, or compressed, digital video signal. The block 110 provides the appropriate decoding according to whatever standard has been used for coding the encoded digital video signal. The block 110 outputs a decoded digital video signal having a video source format (e.g., progressive scan at 24 frames/second). The operation and construction of such a video decoder would be well understood to those skilled in the art.

Then, in block 120, a format converter converts the video source format of the decoded digital video signal to a suitable video display format for display by a particular television receiver or display device. In the example of FIG. 1, a standard 3:2 pulldown algorithm is employed to convert the decoded digital video signal from a video source format that is progressive scan at 24 frames/second, to a video display format that is interlaced at approximately 60 fields/second. Alternatively, the display format may be interlaced at approximately 50 fields/second, in which case a 2:2 pulldown is performed instead. The block 120 outputs a format-converted decoded digital video signal having a video display format (e.g., interlaced at 60 fields/second). Again, the operation and construction of such a format converter implementing a 3:2 or 2:2 pulldown algorithm would be well understood to those skilled in the art.

Meanwhile, in block 130, a video encoding metric calculation module calculates one or more video encoding metric(s) for the encoded digital video signal using coding information and/or other features of the encoded digital video signal. For example, when the encoded digital video signal is an MPEG-2 video data stream, such coding information may include a quantization parameter (q_scale), the number of bits used to code a luminance block (num_bits), etc. Such coding information may be provided within the bitstream of the encoded digital video signal. Exemplary algorithms are described, for example, in International Patent Application serial number IB2003/0057 filed on Dec. 4, 2003 and entitled “A Unified Metric For Digital Video Processing (UMDVP).” The block 130 outputs the video encoding metric(s) corresponding to the decoded digital video signal having the video source format (e.g., 24 frames/sec. for film sequences).

Next, in block 140, a video encoding metric conversion module converts the video encoding metric information output by block 130 into a format corresponding to the format-converted decoded digital video signal output by the format converter in block 120. That is, the block 140: receives at its input the outputs of the video encoding metric(s) corresponding to the decoded digital video signal having the video source format (e.g., 24 frames/sec. for film sequences); executes a conversion algorithm on the received video encoding metric(s); and outputs converted video encoding metric(s) corresponding to the format-converted decoded digital video signal output by the block 120 having the video display format (e.g., interlaced at approximately 60 fields/second.

Finally, in block 150, the converted video encoding metric(s) are employed in an algorithm to enhance the picture quality (e.g., sharpness enhancement, resolution enhancement, etc.) and/or to reduce video compression artifacts in the format-converted decoded digital video signal.

Accordingly, the system and method described above can enhance the quality and/or reduce video artifacts in a video signal after it is decoded and prior to display on a display device.

However, such a system and method suffers from several disadvantages. Converting the video encoding metric(s) so they can be applied to the format-converted decoded digital video signal having the video display format is computationally burdensome. Also, artifact reduction algorithms tend to look for artifacts amongst spatially neighboring pixels. It is rather complex to apply these algorithms to interlaced video data. Furthermore, the quality of the results produced by the picture quality enhancement and/or video compression artifact reduction algorithm(s) is impaired. Assumptions must be made regarding how video encoding metric(s) for a progressive scan signal at a frame rate of 24 frames/second are applied, e.g., to fields of an interlaced signal at a video display rate of 50 or 60 fields/second.

Accordingly, it would be desirable to provide an improved system and method of video quality enhancement and/or artifact reduction using one or more video encoding metric(s) derived from coding information and/or other features of an encoded digital video signal. The present invention is directed to addressing one or more of these concerns.

In one aspect of the invention, a method of processing a digital video signal comprises decoding an encoded digital video signal to produce a decoded digital video signal having a progressive scan format at a frame rate of approximately 24 frames/second; calculating at least one video encoding metric from the encoded digital video signal; executing a video quality improvement algorithm on the decoded digital video signal having the progressive scan format at the frame rate of approximately 24 frames/second, using the calculated video encoding metric, to produce a processed decoded digital video signal having the progressive scan format at the frame rate of approximately 24 frames/second; and converting the processed decoded digital video signal from the progressive scan format at the frame rate of approximately 24 frames/second format to an interlaced format at one of approximately 50 fields/second or approximately 60 fields/second.

In another aspect of the invention, a method of processing a digital video signal for display on a display device comprises decoding an encoded digital video signal to produce a decoded digital video signal having a video source format; calculating at least one video encoding metric from the encoded digital video signal; executing a video quality improvement algorithm on the decoded digital video signal having the video source format, using the calculated video encoding metric, to produce a processed decoded digital video signal having the video source format; and converting the processed decoded digital video signal from the video source format to a video display format suitable for display on the display device.

In yet another aspect of the invention, a system for processing a digital video signal for display on a display device comprises a decoder for decoding an encoded digital video signal to produce a decoded digital video signal at a source frame rate; a video encoding metric calculation module for calculating a video encoding metric from the encoded digital video signal; a post-processor for executing a video quality improvement algorithm on the decoded digital video signal at the source frame rate, using the calculated video encoding metric, to produce a processed decoded digital video signal; and a format converter for converting the processed decoded video signal from the source frame rate to a display frame rate suitable for display on the display device.

FIG. 1 shows an exemplary block diagram illustrating a system and method of video signal enhancement and/or artifact reduction using coding information from a coded video signal;

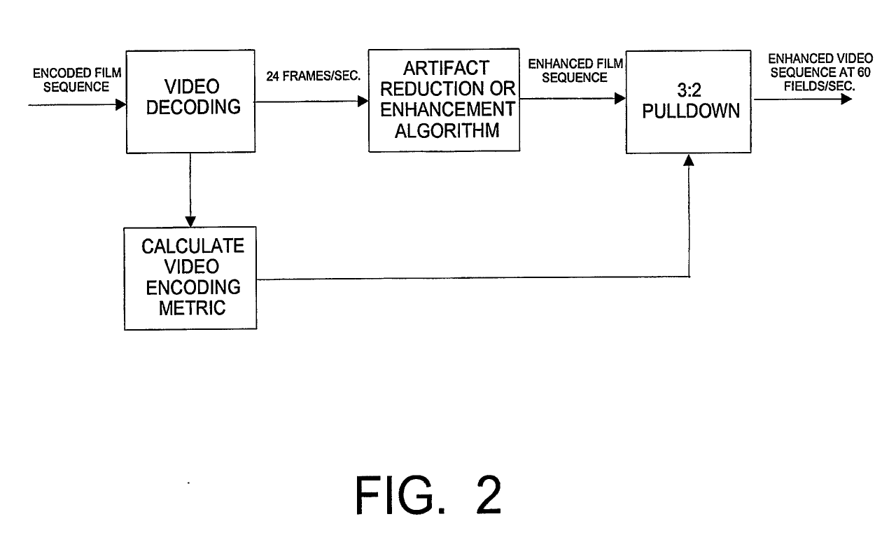

FIG. 2 shows an exemplary block diagram illustrating a system and method of video signal enhancement and/or artifact reduction using coding information from a coded video signal according to one or more aspects of the present invention.

FIG. 2 shows an exemplary block diagram illustrating a system and method of video signal enhancement and/or artifact reduction using coding information from a coded video signal according to one or more aspects of the present invention.

The coded digital video signal may have been encoded using MPEG-1, MPEG-2, MPEG-4, H.26x, or any other desired video-encoding standard. For ease of explanation, hereafter it will be assumed that the encoded video signal has been encoded according to the MPEG-2 standard. Furthermore, in the example of FIG. 2, the digital video signal represents a film sequence that has been encoded at a source frame rate of 24 frames/second.

In a block 210, a video decoder decodes the encoded, or compressed, digital video signal. The block 210 provides the appropriate decoding according to whatever standard has been used for coding the digital video signal. The block 210 outputs a decoded digital video signal having a video source format (e.g., progressive scan at 24 frames/second). The operation and construction of such a video decoder would be well understood to those skilled in the art.

Meanwhile, in block 220, a video encoding metric calculation module calculates one or more video encoding metric(s) for the encoded digital video signal using coding information and/or other features of the encoded digital video signal. For example, when the encoded digital video signal is an MPEG-2 video data stream, such coding information may include a quantization parameter (q_scale), the number of bits used to code a luminance block (num_bits), etc. Such coding information may be provided within the bitstream of the encoded digital video signal. Exemplary algorithms are described, for example, in International Patent Application serial number IB2003/0057 filed on Dec. 4, 2003 and entitled “A Unified Metric For Digital Video Processing (UMDVP).” The block 220 outputs the video encoding metric(s) corresponding to the decoded digital video signal having the video source format (e.g., 24 frames/sec. for film sequences).

Then, in block 230, a post-processor uses the calculated video encoding metric(s) to enhance the picture quality (e.g., sharpness enhancement, resolution enhancement, etc.) and/or to reduce video compression artifacts in the decoded digital video signal by employing the metric(s) in one or more picture quality enhancement and/or video compression artifact reduction algorithm(s). Advantageously, the post-processor 230 operates upon the decoded digital video signal while it is still in the native video source format. Accordingly, identifying artifacts amongst spatially neighboring pixels is simplified. Furthermore, the quality of the results produced by the picture quality enhancement and/or video compression artifact reduction algorithm(s) is improved since, for example, no assumptions are necessary regarding how metric(s) obtained for a progressive scan signal at a frame rate of 24 frames/second are applied, e.g., to fields of an interlaced signal at a video display rate of 50 or 60 fields/second.

Finally, in block 240, a format converter converts the video source format of the processed decoded digital video signal to a suitable video display format for display by a particular television receiver or display device. In the example of FIG. 2, a standard 3:2 pulldown algorithm is employed to convert the processed decoded digital video signal from a video source format that is progressive scan at 24 frames/second, to a video display format that is interlaced at approximately 60 fields/second. Alternatively, the display format may be interlaced at approximately 50 fields/second, in which case a 2:2 pulldown is performed instead. The block 240 outputs a format-converted processed decoded digital video signal having a video display format (e.g., interlaced at approximately 60 fields/second or approximately 50 fields/second). Again, the operation and construction of such a format converter implementing a 3:2 or 2:2 pulldown algorithm would be well understood to those skilled in the art.

Accordingly, the system and method described above can enhance the quality and/or reduce video artifacts in a video signal after it is decoded and prior to display on a display device. Among other things, the computational burden is substantially reduced, compared to the system and method illustrated in FIG. 1.

While embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A method of processing a digital video signal, comprising:
decoding (210) an encoded digital video signal to produce a decoded digital video signal having a progressive scan format at a frame rate of approximately 24 frames/second;
calculating (220) at least one video encoding metric from the encoded digital video signal;
executing a video quality improvement algorithm (230) on the decoded digital video signal having the progressive scan format at the frame rate of approximately 24 frames/second using the calculated video encoding metric, to produce a processed decoded digital video signal having the progressive scan format at the frame rate of approximately 24 frames/second; and
converting (240) the processed decoded digital video signal from the progressive scan format at the frame rate of approximately 24 frames/second format to an interlaced format at one of approximately 50 fields/second or approximately 60 fields/second.

2. The method of claim 1, wherein calculating (220) at least one video encoding metric includes calculating a Unified Metric For Digital Video Processing (UMDVP) value.

3. The method of claim 1, wherein the video encoding metric is calculated using at least one of a quantization parameter or a number of bits employed to code a luminance block of the coded digital video signal.

4. The method of claim 1, wherein converting (240) the processed decoded video signal from the progressive scan format at the frame rate of approximately 24 frames/second format to an interlaced format at approximately 60 fields/second comprises executing a 3:2 pulldown algorithm.

5. The method of claim 1, wherein converting (240) the processed decoded video signal from the progressive scan format at the frame rate of approximately 24 frames/second format to an interlaced format at approximately 50 fields/second comprises executing a 2:2 pulldown algorithm.

6. A method of processing a digital video signal for display on a display device, comprising:
decoding (210) an encoded digital video signal to produce a decoded digital video signal having a video source format;
calculating (220) at least one video encoding metric from the encoded digital video signal;
executing a video quality improvement algorithm (230) on the decoded digital video signal having the video source format using the calculated video encoding metric, to produce a processed decoded digital video signal having the video source format; and
converting (240) the processed decoded digital video signal from the video source format to a video display format suitable for display on the display device.

7. The method of claim 6, where the video source format is progressive scanned at approximately 24 frames/second.

8. The method of claim 6, where the video display format is interlaced at approximately 60 fields/second.

9. The method of claim 6, where the video display format is interlaced at approximately 50 fields/second.

10. The method of claim 6, wherein calculating (220) at least one video encoding metric includes calculating a Unified Metric For Digital Video Processing (UMDVP) value.

11. The method of claim 6, wherein the video encoding metric is calculated using at least one of a quantization parameter or a number of bits employed to code a luminance block of the coded digital video signal.

12. The method of claim 6, wherein converting (240) the processed decoded video signal from the video source format to the video display format comprises executing a 3:2 pulldown algorithm.

13. The method of claim 6, wherein converting (240) the processed decoded video signal from the video source format to the video display format comprises executing a 2:2 pulldown algorithm.

14. A system for processing a digital video signal for display on a display device, comprising:
a decoder (210) for decoding an encoded digital video signal to produce a decoded digital video signal at a source frame rate;
a video encoding metric calculation module (220) for calculating a video encoding metric from the encoded digital video signal;
a post-processor (230) for executing a video quality improvement algorithm on the decoded digital video signal at the source frame rate using the calculated video encoding metric to produce a processed decoded digital video signal; and
a format converter (240) for converting the processed decoded video signal from the source frame rate to a display frame rate suitable for display on the display device.

15. The system of claim 14, where the video source format is progressive scanned at approximately 24 frames/second.

16. The system of claim 14, where the video display format is interlaced at one of approximately 50 fields/second or approximately 60 fields/second.

17. The system of claim 14, wherein video encoding metric calculation module (220) calculates a Unified Metric For Digital Video Processing (UMDVP) value.

18. The system of claim 14, wherein the extracted coding information includes at least one of a quantization parameter or a number of bits employed to code a luminance block of the coded digital video signal.

19. The system of claim 14, wherein the format converter (240) executes a 3:2 pulldown algorithm.

20. The system of claim 14, wherein the format converter (240) executes a 2:2 pulldown algorithm.
